(19) United States
(12) Patent Application Publication
(10) Pub. No.: US 2023/0397574 A1
(43) Pub. Date: Dec. 14, 2023

(54) Pet Scratching Panel

(71) Applicants: Alan Dale Kacic, Tucson, AZ (US); Tyler Alan Kacic, Tucson, AZ (US); Nicholas Kacic, Tucson, AZ (US); Regis Wiegand, Tucson, AZ (US); Rosita Campbel, Tucson, AZ (US); K.C. Innovations LLC, Tucson, AZ (US)

(72) Inventors: Alan Dale Kacic, Tucson, AZ (US); Tyler Alan Kacic, Tucson, AZ (US); Nicholas Kacic, Tucson, AZ (US); Regis Wiegand, Tucson, AZ (US); Rosita Campbell, Tucson, AZ (US)

(21) Appl. No.: 18/333,529

(22) Filed: Jun. 12, 2023

Related U.S. Application Data
(60) Provisional application No. 63/351,210, filed on Jun. 10, 2022.

(51) Int. Cl. A01K 15/02

(52) U.S. Cl. CPC A01K 15/024

(57) ABSTRACT

A pet scratching panel configured to wear down the claws of an animal during interaction with the panel. The scratching panel comprises a base layer, an abrasive layer, and an adhesive for holding an inner base surface of the base layer to an inner abrasive surface of the abrasive layer. An outer abrasive surface of the abrasive layer comprises an abrasive material configured to wear down claws/nails while an outer base surface of the base layer may include a securing portion for limiting movement of the present invention during use. The scratching panel is configured to be used with a litter box, wherein the scratching panel sits on the bottom surface of the litter box with cat litter disposed over the top of the scratching panel.

### FIELD OF THE INVENTION

The present invention relates generally to pet accessories. More specifically, the present invention is a device that files down cat claws in a natural way.

### BACKGROUND OF THE INVENTION

Cats have claws on each paw that grow and sharpen over a short period of time. Specifically, cats' claws have a sharp keratin sheath that is shed every 60 to 90 days. These claws can easily cause personal injury, personal property damage, and trauma to a cat when not properly maintained. Many cats attempt to naturally dull their claws by scratching various surfaces found around them. Various owners also either declaw or trim the claws of the cat every so often. Many cats do not like having their claws trimmed, resulting in a tricky process of trimming which could accidently injure the cat if the claw is trimmed too far back. Further, the declawing process is seen as inhumane by many people as the cat surgically has each claw removed in a procedure that is painful and can lead to more issues for the cat later on down the line.

An objective of the present invention is to provide users with a scratching panel to help cats naturally file down their claws. The present invention intends to provide users with a device that can be easily placed on any surface to keep cat claws in check. The present invention allows for natural maintenance by the cat by leaving the present invention in an areas such as a litter box, removing the need to unnecessarily handle a cat for nail trimming and preventing damage to furniture by cats with unkempt claws. In order to accomplish that, a preferred embodiment of the present invention comprises a panel with an abrasive surface and non-slip properties that allows a cat to naturally file down their claw sharpness.

### SUMMARY OF THE INVENTION

The present invention is a pet scratching panel configured to wear down the claws of an animal when the animal interacts with the panel. The present invention comprises a base layer, an abrasive layer, and an adhesive for holding the base layer to the abrasive layer. An outer abrasive surface of the abrasive layer may be made of an abrasive material configured to wear down claws/nails while an outer base surface of the base layer may include a securing portion for limiting movement of the present invention during use. Thus, the present invention is a scratching panel with an abrasive surface and a base surface that allows a cat to naturally file down their claw sharpness.

### BRIEF DESCRIPTION OF THE DRAWINGS

FIG. 1 is a top front perspective view of the present invention in a box in accordance with at least one embodiment.

FIG. 2 is a top plan view of the present invention in a box in accordance with at least one embodiment.

FIG. 3 is a bottom front perspective view of the present invention in accordance with at least one embodiment.

FIG. 4 is a top rear perspective view of the present invention in accordance with at least one embodiment.

FIG. 5 is a left-side elevation view of the present invention in accordance with at least one embodiment.

FIG. 6 is an exploded view of the present invention in accordance with at least one embodiment.

FIG. 7 is a top front perspective view of the present invention in accordance with at least one embodiment.

FIG. 8 is a bottom rear perspective view of the present invention in accordance with at least one embodiment.

FIG. 9 is a right-side elevation view of the present invention in accordance with at least one embodiment.

FIG. 10 is an exploded view of the present invention in accordance with at least one embodiment.

FIG. 11 is an illustration of the base layer of the present invention in accordance with at least one embodiment.

FIG. 12 is an illustration of the abrasive layer of the present invention in accordance with at least one embodiment.

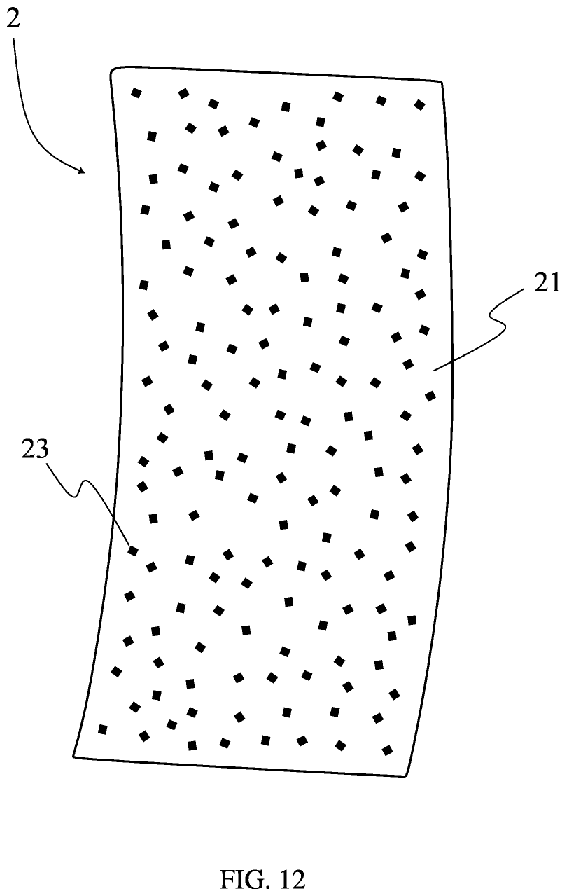

FIG. 13 is an isometric view of the base layer of the present invention in accordance with at least one embodiment.

FIG. 14 is an exploded view of the base layer of the present invention in accordance with at least one embodiment.

### DETAIL DESCRIPTIONS OF THE INVENTION

All illustrations of the drawings are for the purpose of describing selected versions of the present invention and are not intended to limit the scope of the present invention.

The present invention is a scratching panel 100 configured for use by a cat or other animal to wear down claws or nails in a manner that mimics natural outdoor wear. The present invention comprises a base layer 1, an abrasive layer 2, and an adhesive 3. The base layer 1 and the abrasive layer 2 are connected to one another by the adhesive 3, creating a panel having one side for placing on a floor and an opposite abrasive side for scratching.

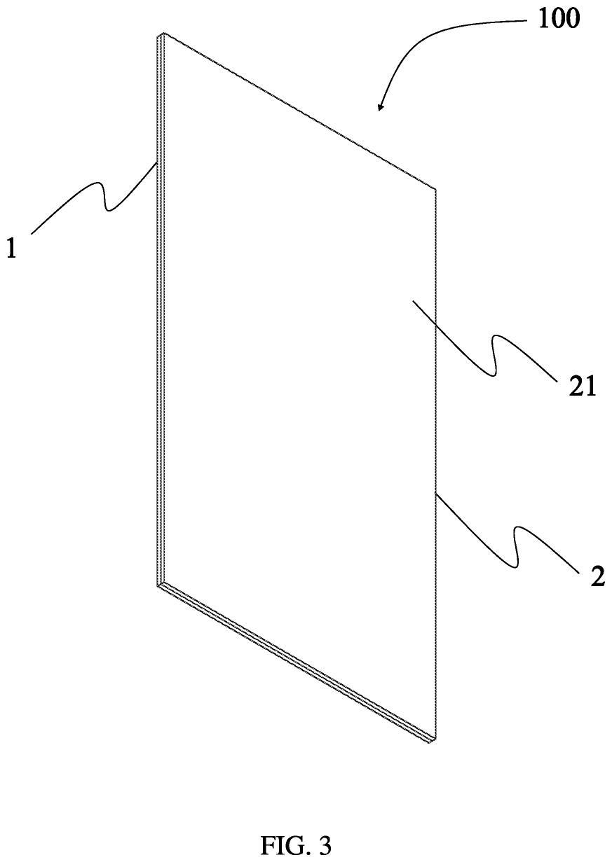

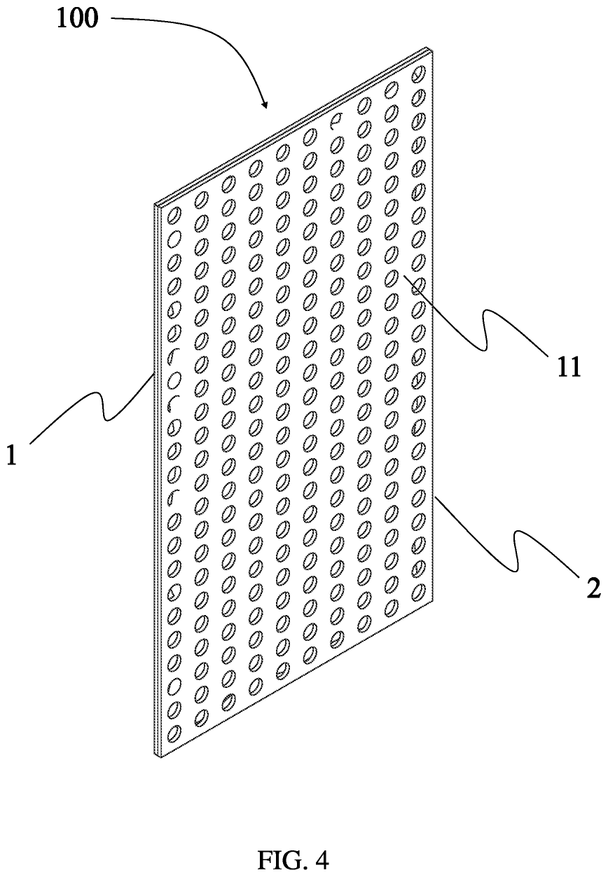

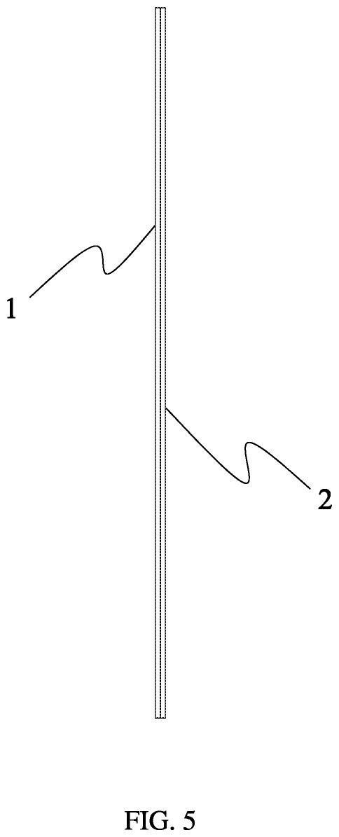

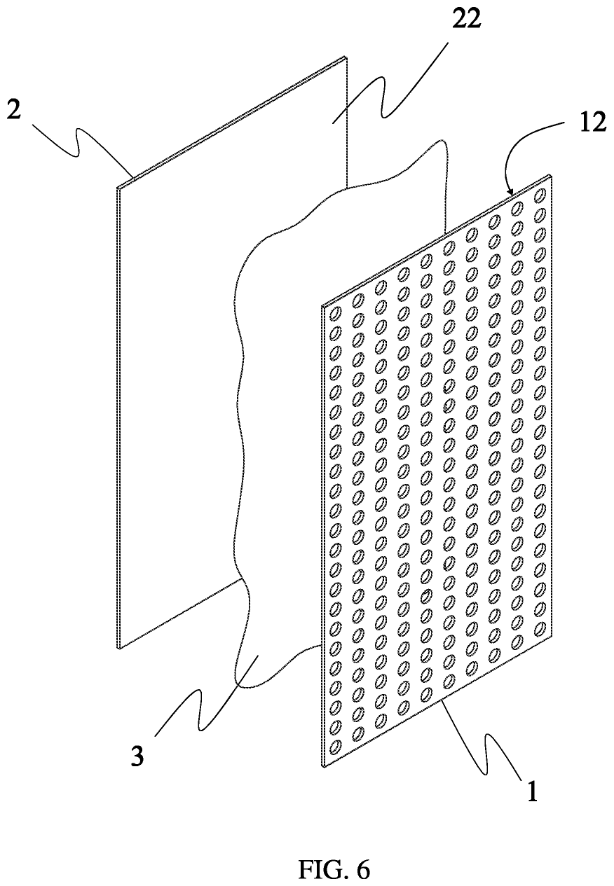

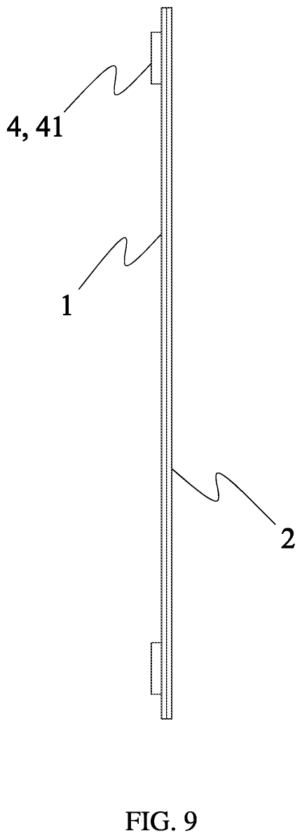

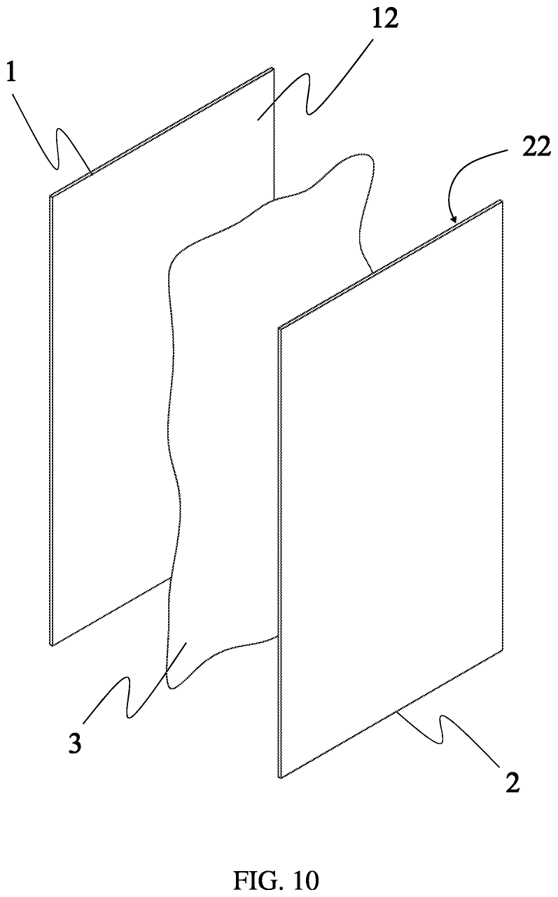

Specifically, referring to FIG. 3-10, the base layer 1 comprises an outer base surface 11 and an inner base surface 12 with the outer base surface 11 being oppositely positioned from the inner base surface 12 on the base layer 1. Similarly, the abrasive layer 2 comprises an outer abrasive surface 21 and an inner abrasive surface 22, wherein the outer abrasive surface 21 is oppositely positioned from the inner abrasive surface 22 on the abrasive layer 2. The base layer 1 and the abrasive layer 2 are connected to one another by the inner base surface 12 and the inner abrasive surface 22 with the adhesive 3 being dispersed between the inner base surface 12 and the inner abrasive surface 22 to hold the base layer 1 and abrasive layer 2 together.

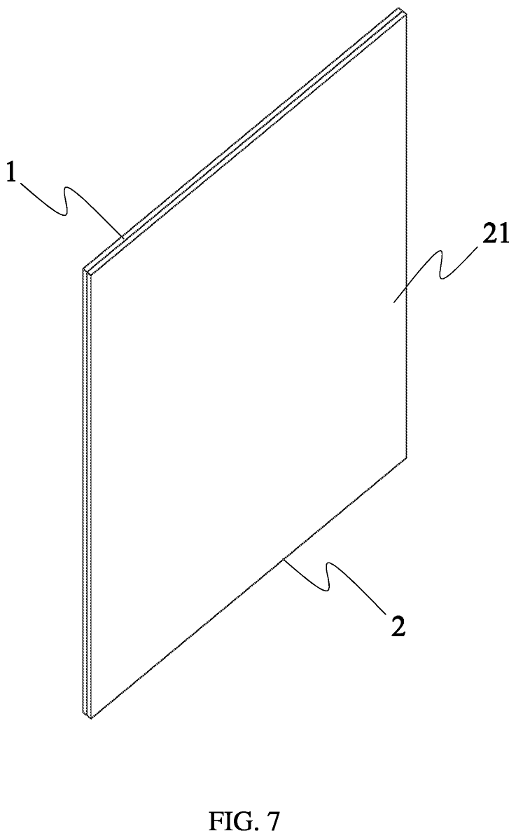

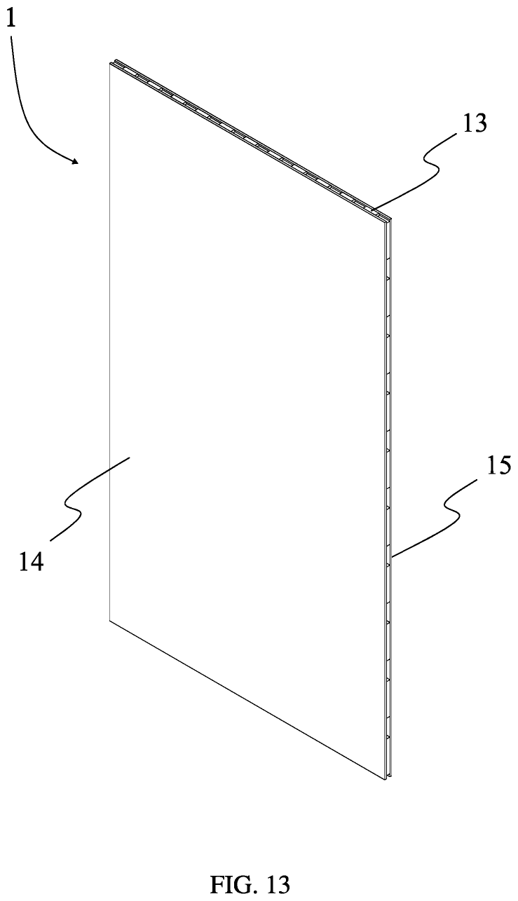

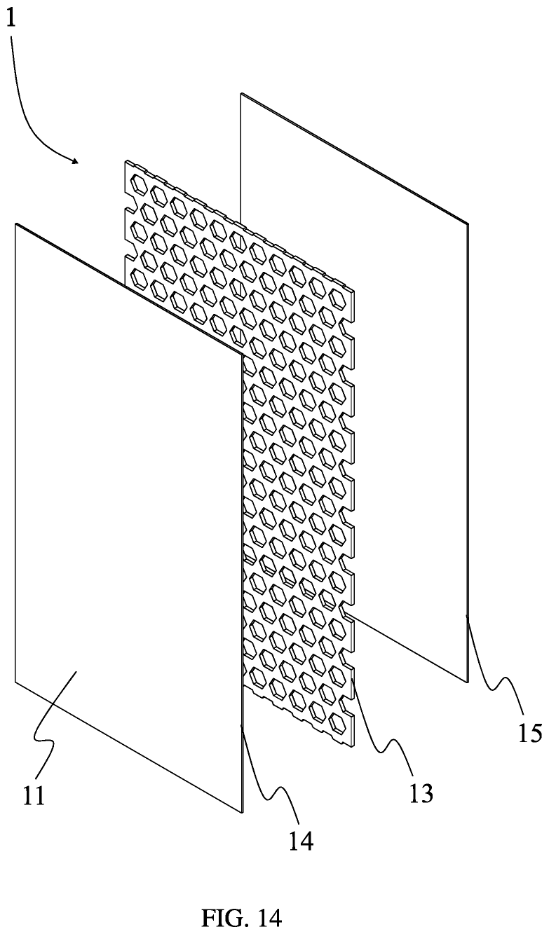

The base layer 1 is a structural layer configured to give a defined shape to the scratching panel 100 and increase the durability of the scratching panel 100. In certain embodiments of the present invention, the base layer 1 is comprised of a rigid material such as plastic to increase structure and durability of the invention as a whole. In the preferred embodiment, as shown in FIG. 7-10, the base layer 1 is made of perforated plastic. Another embodiment of the perforated plastic base layer 1 is shown in FIG. 13-14, in which the base layer 1 further comprises a honeycomb-patterned internal plastic layer 13 sandwiched between a front base structure 14 and a rear base structure 15. In this embodiment, the outer base surface 11 is the outer surface of the front base structure 14 and the inner base surface 12 is the outer surface of the rear base structure 15. In alternative embodiments, as shown in FIG. 3-6, the base layer 1 may be made of a more flexible material such as rubber, allowing the scratching panel 100 to be wrapped around objects or otherwise conformed to different shapes as required for certain uses. In the case of either type of material, the base layer 1 material in all embodiments is water resistant. Development of smell or general moisture may cause a cat to stay away from a product, so limiting the development of smell/moisture and allowing the base layer 1 to be cleaned without retaining water promotes use of the present invention.

The abrasive layer 2 is the component of the present invention configured to wear the claws of a cat or other animal using the scratching panel 100. The abrasive layer 2 is preferably made from a biodegradable sheet. The outer abrasive surface 21 comprises an abrasive material 23 configured to wear down claws. The abrasive material 23 may be any material that capable of frictionally wearing down claws, such as silicon carbide, ceramic alumina, aluminum oxide, and alumina-zirconia, though flint and nickel-based abrasives are not preferred for the present application. In the preferred embodiment, aluminum oxide is used as the abrasive material 23 due to it being porous, dense, and long lasting. Further, while the grit of the abrasive material 23 may vary, the preferred embodiment uses a 320-grit aluminum oxide as the abrasive material 23. Preferably, electrostatic grit coating is used to secure the abrasive material 23 to the outer abrasive surface 21, ensuring that the abrasive material 23 is optimally oriented on the abrasive layer 2. Further, the abrasive material 23 may be covered by a polyurethane coating to create a water resistant finish on the abrasive layer 2.

The adhesive 3 of the present invention may be any adhesive 3 capable of holding together the above referenced materials of the base layer 1 and the abrasive layer 2. The adhesive 3 may be non-toxic to prevent any harm to animals that incidentally consume a portion of the scratching panel 100. Further, the adhesive 3 is preferably odorless to keep animals from being disturbed by unknown scents during use.

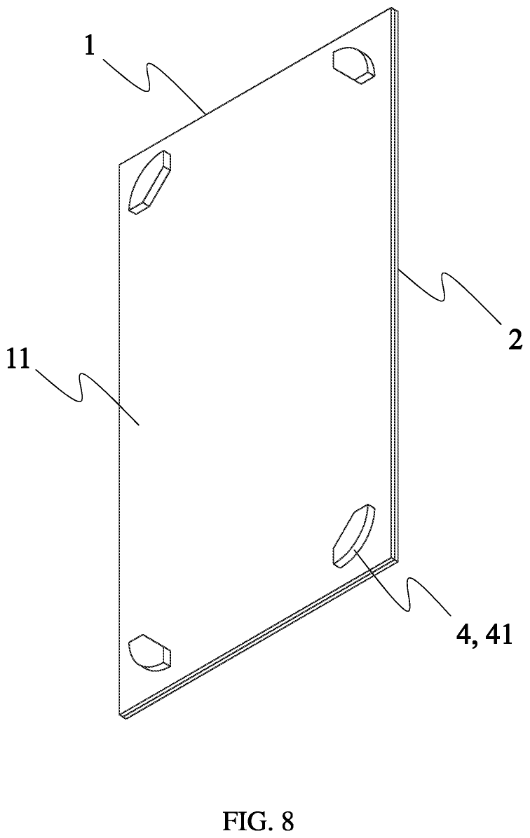

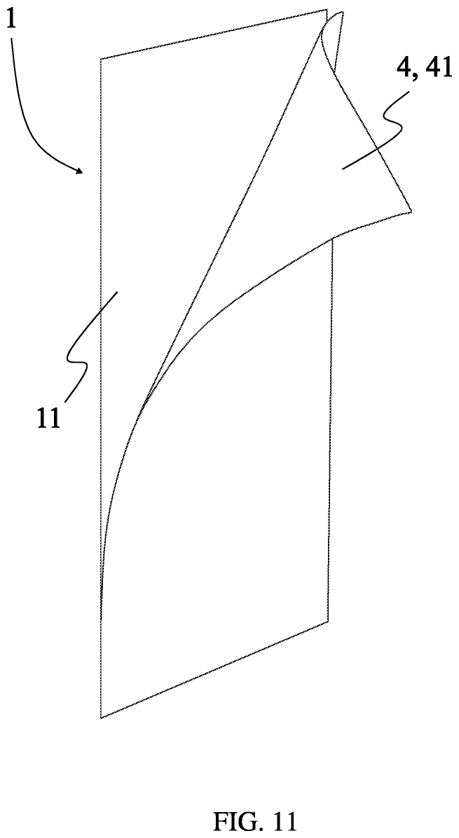

As shown in FIGS. 8, 9, and 11, the present invention may further comprise a securing portion 4. The securing portion 4 is attached to the outer base surface 11 to either fully secure the base layer 1 to an external surface or limit movement of the base layer 1 through non-slip properties. In the preferred embodiment, the securing portion 4 is a plurality of non-slip feet 41. The plurality of non-slip feet 41 may be arranged along the outer base surface 11 such that the scratching panel 100 is limited in sliding movement when placed on a surface. The plurality of non-slip feet 41 is preferably made of silicone, though other slip-resistant materials may also be used. In an alternative embodiment, the securing portion 4 may be a securing adhesive 42 such as a glue or epoxy. In such an embodiment, the outer base surface 11 with the securing adhesive 42 is generally covered by a peelable covering with the peelable covering being removably positioned over the securing adhesive 42 prior to use.

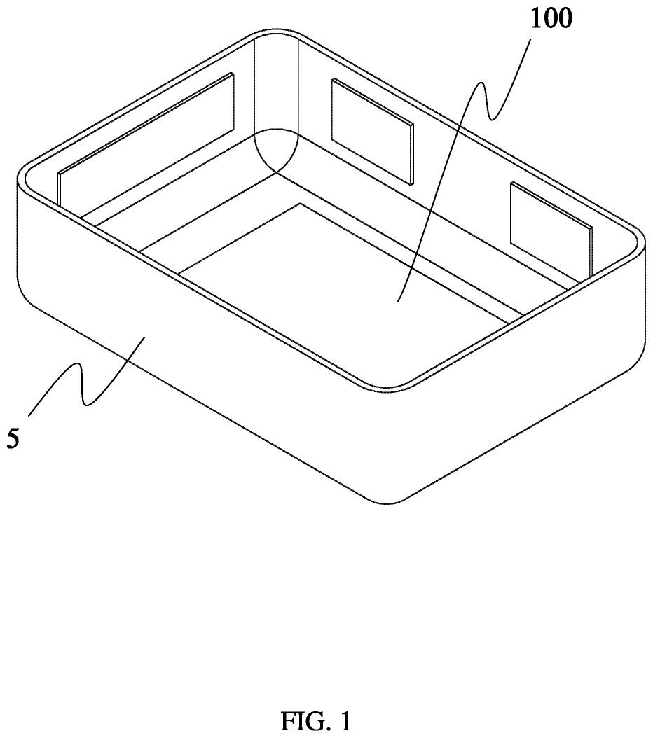

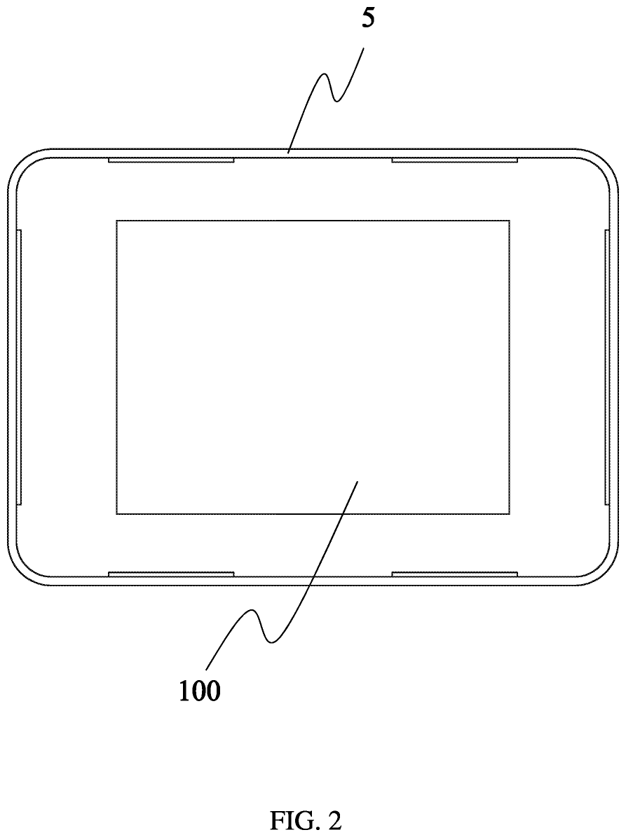

In use, the present invention is placed on a surface with the outer base surface 11 positioned adjacent to the surface and the outer abrasive surface 21 facing outward, exposing the abrasive material 23 for use. In one embodiment, as shown in FIG. 1-2, the present invention may further comprise a box 5, preferably a litter box. The base layer 1 is connected to the box 5 either by setting the base layer 1 in the bottom of the box 5 or securing the base layer 1 to any portion of the box 5 by the securing portion 4. In its preferred use, the base layer 1 is set upon the bottom of the box 5 and the outer adhesive 3 surface is covered at least partially in cat litter. Through this placement, a cat may scratch the abrasive material 23 through or around the cat litter while using the litter box, mimicking an outdoor environment for wearing claws/nails. The scratching panel 100 may be cut into a variety of shapes and sizes to fit the litter box 5 being used.

Although the invention has been explained in relation to its preferred embodiment, it is to be understood that many other possible modifications and variations can be made without departing from the spirit and scope of the invention.

What is claimed is:

1. A pet scratching panel, comprising:
a base layer;
an abrasive layer;
an adhesive;
the base layer having an outer base surface and an inner base surface, wherein the outer base surface is oppositely positioned from the inner base surface on the base layer;
the abrasive layer having an outer abrasive surface and an inner abrasive surface, wherein the outer abrasive surface is oppositely positioned from the inner abrasive surface on the abrasive layer;
the inner base surface being connected to the inner abrasive surface by the adhesive; and
the outer abrasive surface comprising an abrasive material configured to wear down claws.

2. The pet scratching panel of claim 1, wherein the base layer is made of a water resistant material and the adhesive is non-toxic and odorless.

3. The pet scratching panel of claim 1, wherein the base layer is made of a flexible material.

4. The pet scratching panel of claim 1, wherein the base layer is made of a rigid perforated plastic.

5. The pet scratching panel of claim 1, further comprising:
a securing portion;
the securing portion connected to the outer base surface; and
the securing portion configured to secure the base layer to an external surface.

6. The pet scratching panel of claim 1, wherein the securing portion is a plurality of non-slip feet.

7. The pet scratching panel of claim 1, wherein the abrasive material is aluminum oxide.

8. The pet scratching panel of claim 1, wherein the abrasive material is 320 grit aluminum oxide.

9. The pet scratching panel of claim 1, further comprising:
a box; and
the base layer being connected to the box.

10. A pet scratching panel, comprising:
a base layer;
an abrasive layer;
an adhesive;
a securing portion;
the base layer having an outer base surface and an inner base surface, wherein the outer base surface is oppositely positioned from the inner base surface on the base layer;
the base layer being made of a water-resistant material;
the abrasive layer having an outer abrasive surface and an inner abrasive surface, wherein the outer abrasive surface is oppositely positioned from the inner abrasive surface on the abrasive layer;
the inner base surface being connected to the inner abrasive surface by the adhesive;
the adhesive being non-toxic and odorless;
the outer abrasive surface comprising an abrasive material configured to wear down claws;
the abrasive material being aluminum oxide;
the securing portion connected to the outer base surface; and
the securing portion configured to secure the base layer to an external surface.

11. The pet scratching panel of claim 10, wherein the base layer is made of a flexible material.

12. The pet scratching panel of claim 10, wherein the base layer is made of a rigid perforated plastic.

13. The pet scratching panel of claim 10, wherein the securing portion is a plurality of non-slip feet.

14. The pet scratching panel of claim 10, wherein the abrasive material is 320 grit aluminum oxide.

15. The pet scratching panel of claim 10, further comprising:
a box; and
the base layer being connected to the box.

16. A pet scratching panel, comprising:
a base layer;
an abrasive layer;
an adhesive;
a box;
the base layer having an outer base surface and an inner base surface, wherein the outer base surface is oppositely positioned from the inner base surface on the base layer;
the base layer being made of a water-resistant material;
the abrasive layer having an outer abrasive surface and an inner abrasive surface, wherein the outer abrasive surface is oppositely positioned from the inner abrasive surface on the abrasive layer;
the inner base surface being connected to the inner abrasive surface by the adhesive;
the adhesive being non-toxic and odorless;
the base layer being connected to the box; and
the outer abrasive surface comprising an abrasive material configured to wear down claws.

17. The pet scratching panel of claim 16, further comprising:
a securing portion;
the securing portion being a plurality of non-slip feet;
the securing portion connected to the outer base surface; and
the securing portion configured to secure the base layer to an external surface.

18. The pet scratching panel of claim 16, wherein the base layer is made of a flexible material.

19. The pet scratching panel of claim 16, wherein the base layer is made of a rigid perforated plastic.

20. The pet scratching panel of claim 16, wherein the abrasive material is 320 grit aluminum oxide.
